(19) United States
(12) Patent Application Publication
(10) Pub. No.: US 2008/0062945 A1
(43) Pub. Date: Mar. 13, 2008

(54) SELECTING A LEADER NODE FOR AN AD HOC NETWORK BASED ON SERVICES

(75) Inventors: Ramandeep Ahuja, Chicago, IL (US); Surender Kumar, Naperville, IL (US); Mark D. Seaborn, Algonquin, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/530,690

(22) Filed: Sep. 11, 2006

(51) Int. Cl. H04B 7/216

(52) U.S. Cl. 370/342

(57) ABSTRACT

Techniques are provided for forming networks based on services offered or provided by particular leader nodes. Client nodes in the network can select a particular leader node based on a desired service offered or provided by the particular leader node. The client nodes can become a part of a different structured network such that the client nodes can have access to a desired service provided, either directly or indirectly, by the particular leader node.

### FIELD OF THE INVENTION

The present invention relates generally to wireless communications and more particularly to forming structured networks that provide services to nodes in that structured network.

### BACKGROUND

Ad hoc networks are self-forming networks including a number of nodes which can operate with or without any fixed infrastructure, and in some cases the ad hoc network is formed entirely of mobile nodes. An ad hoc network typically includes a number of geographically-distributed, potentially mobile nodes which are wirelessly connected to each other by one or more logical links (e.g., radio frequency communication channels). The nodes can be fixed or mobile and can communicate with each other over a wireless media with or without the support of an infrastructure-based or wired network. Logical links between these nodes can change dynamically in an arbitrary manner as existing nodes move within the ad hoc network, as new nodes join or enter the ad hoc network, or as existing nodes leave or exit the ad hoc network. A single-hop logical link can only exist between two nodes when they are within direct communication range. A multi-hop logical link can only exist between two nodes whenever a set of single-hop logical links can be used to construct a path between the nodes. Such multi-hop logical links are either instantaneously coherent (e.g. all single-hop links are present at the same time) or deferred coherent (e.g. all single-hop links are expected to be present or were present over a period of time).

A node typically includes an ad hoc interface, such as an IEEE 802.11 interface, which continuously scans for other nodes in its ad hoc network to allow for “proximity-based” communications. For example, when two nodes are moving about those nodes can communicate when within communication range of each other. Nodes can operate in at least two different modes within a network: an ad hoc mode and an infrastructure mode.

In infrastructure mode, typically only one communication hop is used from a mobile node to an access point (AP) or other base station (i.e. a special node with an infrastructure connection). For example, IEEE 802.11 protocols assume that a particular mobile node can rely on the presence of other nodes or access points (APs) in close proximity at any given time. For instance, IEEE 802.11-based protocols assume the availability of internet access points (APs) which provide nodes in the network with access to different services on, for example, the Internet or other infrastructure.

An ad hoc network can operate in the absence or presence of infrastructure components such as a base station or Wireless Local Area Network (WLAN) access point (AP). In ad hoc mode, communications between a source node and a destination node can single-hop or multi-hop over logical links locally between nodes without implicating infrastructure. Such nodes are sometimes referred to as peer nodes or peers in this context. Processes sometimes referred to as service discovery or peer discovery can be used so that a particular node can recognize when another node is in its proximity.

Some ad hoc networks provide a central leader node (sometimes referred to as a “root node” or “cluster head,”) which, for example, performs association and authentication, and enhances routing for its client nodes within the network. A “structured ad hoc network” refers to an ad hoc network that has a leader node and implements at least one of the many ad-hoc routing protocols. Depending on the particular type of “structured network,” the leader node may or may not be connected to a Local Area Network (LAN).

In today's networks, when a first leader node of a structured ad hoc network comes within communication range of a second leader node (of a structured network) that offers access to services (e.g., backhaul) which the first leader node does not, the client nodes associated with the first leader node cannot hop through the first leader node to get access to the services (e.g., backhaul) offered or provided by the second leader node.

### BRIEF DESCRIPTION OF THE FIGURES

The accompanying figures serve to further illustrate various exemplary embodiments and to explain various principles and advantages all in accordance with the present invention.

FIG. 1A is a block diagram of an exemplary communication network at a first time instant;

FIG. 1B is a block diagram of the exemplary communication network of FIG. 1A at a second time instant;

FIG. 2 is a block diagram of an exemplary node;

FIG. 3 is a flowchart showing an exemplary technique for providing client nodes of a leader node with access to a desired service provided by another leader node in accordance with some embodiments of the invention;

FIG. 4 is a data structure showing an exemplary implementation of a Hello message used in accordance with some embodiments of the invention;

FIG. 5 is a data structure showing an exemplary implementation of a Hello message used in accordance with some exemplary embodiments of the invention;

FIG. 6 is a message flow diagram showing messages exchanged when a leader node converts from being a leader node to being an Enhanced Client (EC), and client nodes associated with that leader node gain access to a desired service provided by another leader node according to one exemplary implementation; and

FIG. 7 is a message flow diagram showing messages exchanged when an Enhanced Client (EC) node detects that it is no longer within the communication range of the leader node and also resumes its role as a leader node according to one exemplary implementation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to providing client nodes of a leader node with access to a desired service provided (directly or indirectly) by another leader node. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein can be comprised of one or more conventional processors and unique stored program instructions that control the one or more processors to implement, in conjunction with certain non-processor circuits, some, most, or all of the functions for providing client nodes of a leader node with access to a desired service provided (directly or indirectly) by another leader node as described herein. The non-processor circuits can include, but are not limited to, a radio receiver, a radio transmitter, signal drivers, clock circuits, power source circuits, and user input devices. As such, these functions can be interpreted as steps of a method for providing client nodes of a leader node with access to a desired service provided (directly or indirectly) by another leader node. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In this document, relational terms such as first and second, and the like can be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus. An element proceeded by “comprises . . . a” does not, without more constraints, preclude the existence of additional identical elements in the process, method, article, or apparatus that comprises the element. The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

### Definitions

As used herein, the term “ad hoc network” refers to a self-configuring network of nodes connected by wireless links, the union of which form an arbitrary topology.

As used herein, the term “Access Point (AP)” refers to a device connected to a local area network (LAN) that enables remote wireless nodes to communicate with the LAN. An AP connects wireless communication devices together to form a wireless network. In many cases, the AP connects to a wired network, and can relay data between wireless devices and wired devices. In one implementation, an AP may comprise an Intelligent Access Point (IAP). An IAP is distinguishable from a regular AP in that an IAP implements an Ad Hoc On-Demand Distance Vector (AODV)-based routing protocol such as a Mesh Scalable Routing (MSR) protocol such as that disclosed in U.S. Pat. No. 7,061,925 B2, entitled “System and Method for Decreasing Latency in Locating Routes Between Nodes in a Wireless Communication Network” assigned to the assignee of the present invention, its contents being incorporated by reference in its entirety herein.

As used herein, the term “structured network” refers to a network with a central Leader Node (LN). Depending on the particular type of “structured network,” the LN may or may not be connected to a Local Area Network (LAN). As used herein, the term “structured ad hoc network” refers to an ad hoc network that has a Leader Node (LN). A “structured ad hoc network” typically implements at least one of the many ad-hoc routing protocols that work with the LN.

As used here, a “leader” node refers to a node in a network where communication traffic converges for a defined group of nodes. A leader node is responsible for providing key network services that help define the network hierarchy. A leader node can be any node that has been enabled with functionality to form a network. For example, a leader node can perform association/authentication, and can enhance routing within the network. A leader node may also offer and/or provide other nodes with access to services unrelated to the forming of a network but which are desired by other nodes. A leader node can also indicate which other nodes in the system provide desired services.

As used herein, the term “desired service” is used to refer to a service that is offered or provided (either directly or indirectly) by one leader node to client nodes of another leader node which does not provide that service. Examples of a “desired service” may comprise, for example, infrastructure access, a wireless or wired backhaul link, a Domain Name Server (DNS), authentication services, a video server including those with video archiving capability, a media server, location-based service(s), messaging servers, such as instant messaging server (IMS), a gateway into another network(1xEVDO/IMS, Project 25), a call controller (e.g., participating or controlling server in Push-to-talk Over Cellular (POC) service environment), etc.

As used herein, the term “enhanced client” node refers to a node in a structured ad-hoc network which has the ability to become a leader node. Likewise, in certain situations, a leader node can transition to being an enhanced client node.

### Overview

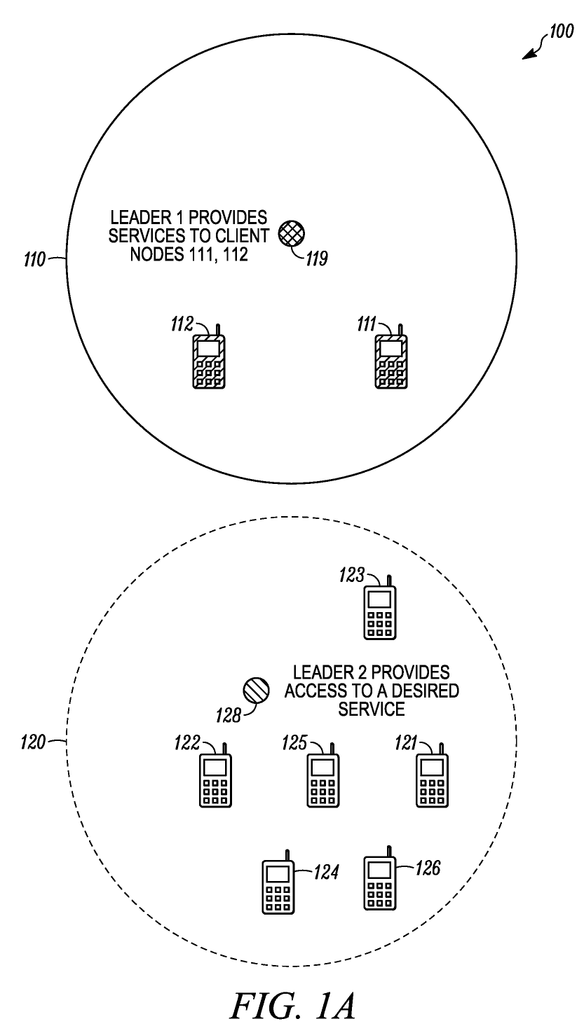

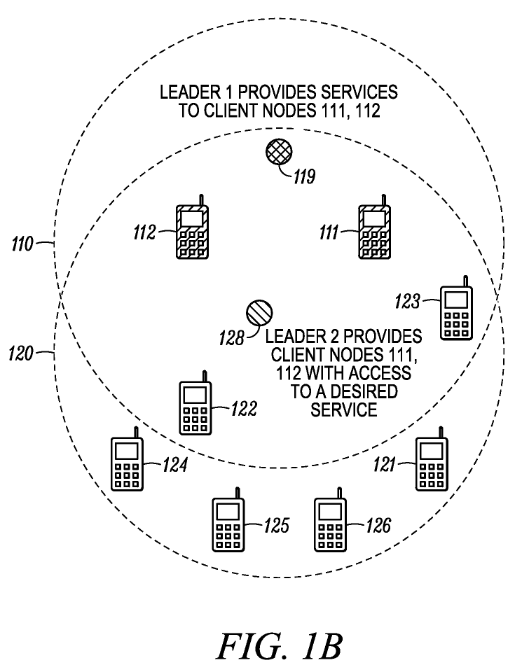

The present invention comprises techniques for providing client nodes with the ability to become a part of a different structured network such that the client nodes can have access to a desired service provided by another leader node. Before describing these techniques in detail a brief description of an exemplary structured ad hoc communication network (FIGS. 1A and 1B) and an exemplary node (FIG. 2) for use in such an exemplary ad hoc communication network is described herein.

FIG. 1A is a block diagram of an exemplary communication network 100 at a first time instant. The ad hoc communication network 100 comprises a plurality of nodes 111, 112, 121-126 each having wireless repeater and routing capability, and leader nodes 119, 128.

In this particular example shown in FIG. 1A, the leader node 119 and the leader node 128 are access points (APs), such as Intelligent Access Points (IAPs). The leader node 119 is part of an ad hoc network which also comprises a number of first client nodes 111, 112. The leader node 119 provides services to the client nodes 111, 112 in the ad hoc network. In this particular example, the leader node 128 is part of a structured ad hoc network which also comprises a number of second client nodes 121-126, and is capable of providing a desired service or services to first client nodes 111, 112 in the ad hoc network once the leader node 119 enters the vicinity or “communication range” of the leader node 128.

The nodes 111, 112, 121-126 can support peer-to-peer communication without the need for wired infrastructure or other networks. The nodes 111, 112, 121-126 can be wireless devices capable of transmitting and receiving packetized audio, video and/or data information. Some of the components in an exemplary node, such as a processor, transmitter, receiver and antenna, are described below in FIG. 2. A node can be stationary or mobile at any particular instant in time, and can include devices configured to communicate through a wireless channel. A node can be embodied as any of a number of types of devices including but not limited to a personal computer (PC) having an external or internal wireless modem, a PC card, a compact flash, a wireless communication device such as a cellular telephone or a personal digital assistant (PDA). In one implementation, the wireless device comprises a mobile radio which can also be called a mobile station (MS), mobile equipment (ME) or user equipment (UE).

The nodes 111, 112, 121-126 can communicate information packets over wireless carrier frequencies, each of which includes one or more wireless communication channels depending on the multiple access scheme utilized in the network 100.

The nodes 111, 112, 121-126 can also communicate with infrastructure components, such as APs 119, 128, which are typically, but not necessarily required to be, coupled to a wired network (not shown) and can provide one or more sources of audio, video and/or data information. The APs 119, 128 can be a node, base station, or other wireless access point that complies with the IEEE 802.11 Standard or other wireless local area network (WLAN) Standards, or the like.

The ad hoc communication network 100 can implement routing intelligence, which is typically distributed among nodes 111, 112, 121-126 to help improve overall network performance. In the ad hoc network 100, communications to or from nodes 111, 112, 121-126 can “hop” through each other to reach other nodes 111, 112, 121-126 in the network. In other words, nodes in close proximity can receive transmissions from nearby nodes utilizing the ad hoc air interface and relay these transmissions to other nodes, including access points or nodes with links to other wired or wireless networks.

When access to a service is desired, communications from nodes 111, 112, 121-126 can hop to an AP. Although not shown in FIG. 1, it will be appreciated by those of ordinary skill in the art that the nodes 111, 112, 121-126, can also communicate information packets with a wide area network (WAN) such as a cellular-based network (not shown) over wireless carrier frequencies, each of which includes one or more wireless communication channels depending on the multiple access scheme utilized in the cellular-based network.

Each node 111, 112, 119, 121-126 and 128 can advertise its presence to other nodes by periodically transmitting an announcement or advertisement message (e.g., beacon message, Hello message, or other status message used to announce the presence of a node, etc.). The terms announcement message, advertisement message and Hello message are used interchangeably throughout this description. In turn, each node can identify its neighbor nodes, and maintain a neighbor list of nodes in proximity to that node. As used herein, a “neighbor node” is a node which is one hop away from the node such that the nodes may communicate with each other. A particular node's neighbor list changes dynamically as the topology of the network changes. At the particular instant in time shown in FIG. 1A, leader node 119 has two neighbor nodes—nodes 111, 112.

As discussed above, the neighborhood topology of a particular node can change rapidly over time. In particular, the neighbor nodes within operable range of a particular node can change regularly, as many nodes are mobile and, therefore, can leave the operable radio frequency (RF) range of the particular node. Other neighbor nodes can be fixed or stationary and, therefore, do not leave the operable RF range. The “operable RF range” (i.e., within the neighborhood topology) of a particular node encompasses those fixed or mobile nodes in close enough proximity to the particular node, such that the signal strength between the nodes is sufficiently strong for coordinated actions between the nodes (e.g., data transmission actions) to occur. Moreover, it is possible that the particular node, itself, is mobile and encounters new neighborhood topologies, as it moves from one location to another, in the form of a partially-new group or entirely-new group of neighboring fixed and mobile nodes. As a particular mobile node enters an area, for example, it will hear or encounter traffic from other nodes in the vicinity or neighborhood. Such an encounter will also provide the particular mobile node with signal strength information about the neighboring nodes that it is hearing from, which can include, for example, Received Signal Strength Indication (RSSI) and Bit Error Rate (BER). FIGS. 1A and 1B illustrate mobility of nodes in the network 100 and how neighbor node topologies change at different time instances.

FIG. 1B is a block diagram of the exemplary communication network 100 of FIG. 1A at a second time instant. During the time period which elapses between the first time (FIG. 1A) and the second time (FIG. 1B), some of the nodes have moved relative to each other such that leader node 119 is now within communication range of leader node 128. When leader node 119 detects leader node 128, the leader node 119 can inform client nodes 111, 112 of the presence of leader node 128, including services the leader node 128 can provide to the client nodes 111, 112.

FIG. 2 is a block diagram of an exemplary node 200. The node 200 comprises a processor 201, a transceiver 202 including a transmitter circuitry 203 and a receiver circuitry 205, an antenna 206, a program memory 209 for storing operating instructions that are executed by the processor 201, a buffer memory 211, and one or more communication interfaces 213. Although not shown, the node 200 also preferably includes an antenna switch, duplexer, circulator, or other highly isolative means (not shown) for intermittently providing information packets from the transmitter circuitry 203 to the antenna 206 and from the antenna 206 to the receiver circuitry 205. The node 200 is preferably an integrated unit containing at least all the elements depicted in FIG. 2, as well as any other elements necessary for the node 200 to perform its particular electronic function. Alternatively, the node 200 can comprise a collection of appropriately interconnected units or devices, wherein such units or devices perform functions that are equivalent to the functions performed by the elements of the node 200.

The processor 201 preferably includes one or more microprocessors, microcontrollers, DSPs (digital signal processors), state machines, logic circuitry, or any other device or devices that process information based on operational or programming instructions. Such operational or programming instructions are preferably stored in the program memory 209. The program memory 209 can be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card, external subscriber identity module (SIM) card or any other medium for storing digital information. One of ordinary skill in the art will recognize that when the processor 201 has one or more of its functions performed by a state machine or logic circuitry, the memory 209 containing the corresponding operational instructions can be embedded within the state machine or logic circuitry. The operations performed by the processor 201 and the other elements of the node 200 are described in detail below.

The transmitter circuitry 203 and the receiver circuitry 205 enable the node 200 to communicate information packets to and acquire information packets from the other nodes. In this regard, the transmitter circuitry 203 and the receiver circuitry 205 include appropriate, conventional circuitry to enable digital or analog transmissions over a wireless communication channel. The transmitter circuitry 203 and the receiver circuitry 205 can operate over an ad hoc networking air interface (e.g., Bluetooth, IEEE 802.11, IEEE 802.15, and the like).

The implementations of the transmitter circuitry 203 and the receiver circuitry 205 depend on the implementation of the node 200. For example, the transmitter circuitry 203 and the receiver circuitry 205 can be implemented as an appropriate wireless modem, or as conventional transmitting and receiving components of two-way wireless communication devices. In the event that the transmitter circuitry 203 and the receiver circuitry 205 are implemented as a wireless modem, the modem can be internal to the node 200 or insertable into the node 200 (e.g., embodied in a wireless radio frequency (RF) modem implemented on a Personal Computer Memory Card International Association (PCMCIA) card). For a wireless communication device, the transmitter circuitry 203 and the receiver circuitry 205 are preferably implemented as part of the wireless device hardware and software architecture in accordance with known techniques. One of ordinary skill in the art will recognize that most, if not all, of the functions of the transmitter circuitry 203 and/or the receiver circuitry 205 can be implemented in a processor, such as the processor 201. However, the processor 201, the transmitter circuitry 203, and the receiver circuitry 205 have been artificially partitioned herein to facilitate a better understanding.

The receiver circuitry 205 is capable of receiving RF signals from at least one frequency band and optionally multiple frequency bands, if the communications with the proximate device are in a frequency band other than that of the network communications. The receiver circuitry 205 can optionally comprise a first receiver and a second receiver, or one receiver capable of receiving in two or more bands. The receiver 205, depending on the mode of operation, can be tuned to receive, for example, Bluetooth or wireless local area network (WLAN), such as IEEE 802.11, communication signals. The transceiver 202 includes at least one set of transmitter circuitry 203. At least one transmitter 203 can be capable of transmitting to multiple devices potentially in multiple frequency bands.

The antenna 206 comprises any known or developed structure for radiating and receiving electromagnetic energy in the frequency range containing the wireless carrier frequencies.

The buffer memory 211 can be any form of volatile memory, such as RAM, and is used for temporarily storing received information packets in accordance with the present invention.

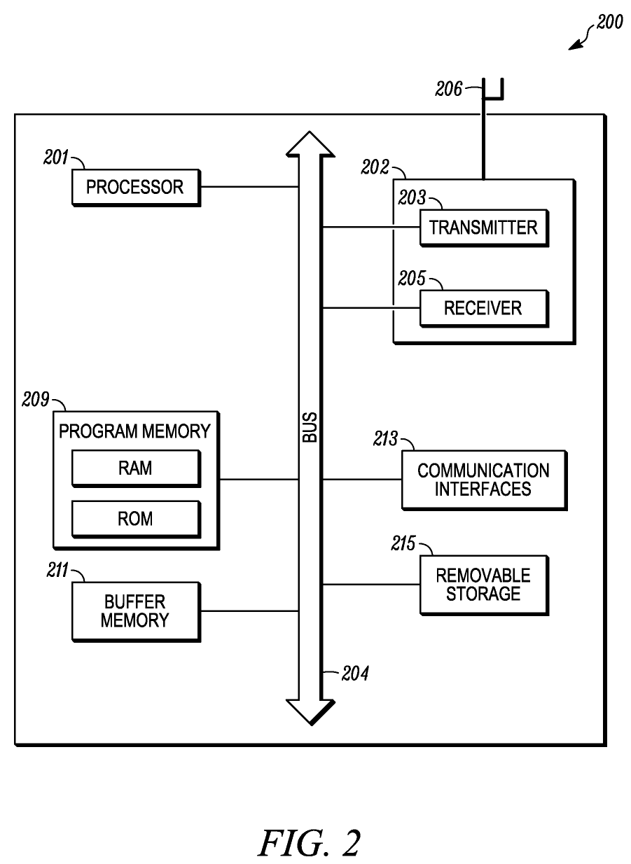

FIG. 3 is a flowchart showing an exemplary technique 300 for providing client nodes 111, 112 of a leader node 119 with access to a desired service provided by another leader node 128 in accordance with some embodiments of the invention.

In this exemplary embodiment, the leader node 119 provides service(s) to client nodes 111, 112, but does not provide or have access to a desired service or services which the leader node 128 can offer or provide the client nodes 111, 112. The leader node 119 regularly scans for announcement messages (e.g., Hello messages) from other leader nodes over one or more wireless channels.

At step 310, the leader node 119 detects the leader node 128 when the leader node 119 enters a communication range of the leader node 128. As used herein, the term “communication range” is used to refer to the RF communication range or coverage area in a wireless network. For example, in one implementation, when the leader node 119 enters the communication range of the leader node 128, the leader node 119 receives a first announcement message over a wireless channel from the leader node 128. This first announcement message comprises, among other things, capability information of the leader node 128. As used herein, the term “capability information” refers to information regarding the services or applications provided or offered by a leader node to other nodes. The leader node 119 can analyze the capability information of the leader node 128, and determine, among other things, that leader node 128 has access to a desired service. In one implementation, services that are available can be advertised in a mask in a services field of the announcement message. For instance, a node can check the mask of each announcement message against its own mask. When the node determines that the mask is different than its own mask, it can take appropriate action.

At step 320, the leader node 119 decides to establish a route to the leader node 128 based on the capability of the leader node 128 to offer the client nodes 111, 112 access to the desired service. This service-based route establishment decision differs from route establishment techniques used in Ad Hoc routing protocols, such as, AODV-based routing protocol, Dynamic Source Routing (DSR) protocol, etc., since the route discovery is not triggered by the node trying to send data to the leader node. For instance, the AODV routing protocol's algorithm creates routes between nodes only when the routes are requested by the source nodes, giving the network the flexibility to allow nodes to enter and leave the network at will. Routes remain active only as long as data packets are traveling along the paths from the source to the destination. When the source stops sending packets, the path will time out and close.

At step 330, the leader node 119 establishes a route to the leader node 128. For instance, in one implementation, the leader node 119 can transmit a bind request message to the leader node 128 which includes association information for leader node 119 and client nodes 111, 112 of leader node 119. The bind request message associates the leader node 119 to the leader node 128, and is similar to an 802.11 Medium Access Control (MAC) Association Request in an 802.11 network that is sourced from a client to an AP to let the AP know about a client's presence. Once the leader node 128 authenticates the leader node 119 (if necessary), the leader node 119 transmits the client node information for the client nodes 111, 112 to the leader node 128.

At step 340, the leader node 119 disables leader node functionality offered by the leader node 119 to client nodes 111, 112, and enables Enhanced Client (EC) functionality at the leader node 119 such that the leader node 119 becomes an EC node which continues to provide its service(s) to the client nodes 111, 112.

At step 350, the leader node 119 advertises the desired service access capability of the leader node 128 to the client nodes 111, 112 of the leader node 119 to offer access to the desired service(s) to the client nodes 111, 112. For example, in one implementation, the leader node 119 can transmit a second announcement message which comprises a MAC address of the leader node 128, an indication that the leader node 119 is about to transition to being an Enhanced Client (EC) node, and an indication that the leader node 128 is now reachable and available to provide the client nodes 111, 112 of the leader node 119 with access to the desired service.

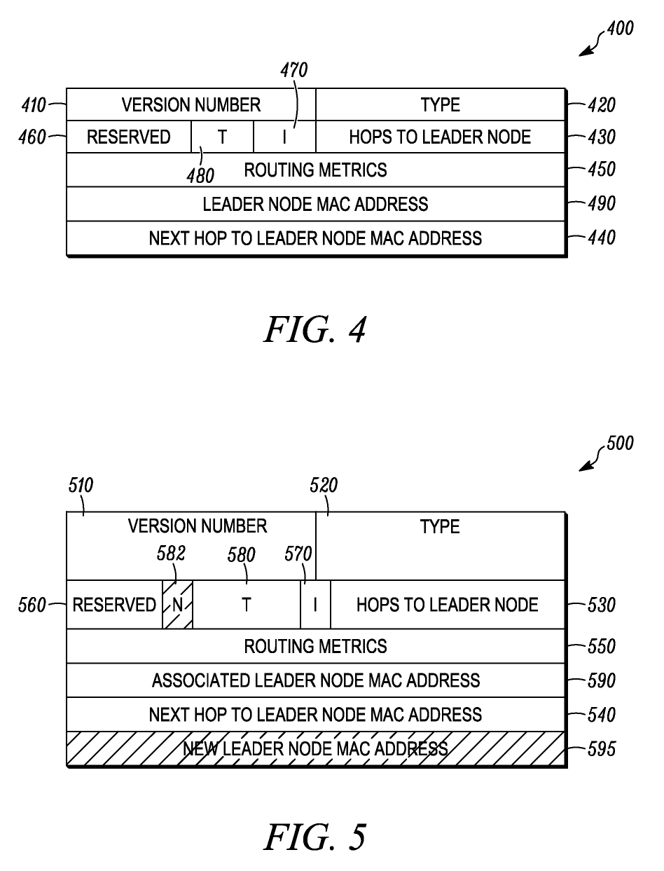

For example, in one implementation, the second announcement message comprises a Hello message, such as that shown in FIG. 5 below, which can include a flag that which indicates that the leader node 128 is providing the client nodes 111, 112 with access to the desired service and that the leader node 119 is about to transition to being an Enhanced Client (EC) node. In the implementation shown in FIG. 5, which will be described in detail below, the flag is denoted with the symbol N. The “N flag” of this announcement message, when set, indicates that a new Leader Node is available and the current leader node is about to transition to an Enhanced Client. This will indicate to the client nodes to update their routing tables with the MAC address of the second leader node and also to use the EC 119 as the next hop to the second leader node.

When another leader node (not shown in FIGS. 1A or 1B) comes within the communication range of the EC 119, that leader node can either become an EC itself or offer its services (as a leader node) to client nodes 111, 112 associated with the EC 119.

At step 360, the EC 119 regularly checks or determines that it is still within the communication range of the leader node 128. For example, in one implementation, the EC 119 can determine whether it continues to receive a signal, such as an announcement message, Hello message or beacon signal, from the leader node 128 to determine whether it is still within the communication range of the leader node 128. If the EC 119 determines that it is still within the communication range of the leader node 128, then the process 300, after waiting at step 370, loops back to step 360.

If the EC 119 determines that it is no longer within the communication range of the leader node 128 (e.g., stops receiving a message or signal from the leader node 128) at step 360, then at step 380, the EC 119 enables leader node functionality offered to client nodes 111, 112 to resume its status as a leader node, and disables Enhanced Client (EC) functionality at the leader node 119. At step 390, the leader node 119 transmits a third announcement message which comprises a MAC address of the leader node 119, an indication which indicates that the desired service is no longer available to the client nodes 111, 112, and an indication which indicates that the leader node 119 is about to transition from being the Enhanced Client (EC) node to being the leader node 119. The leader node 119 continues to provide the client nodes 111, 112 with access to the service(s) of leader node 119. For example, in one implementation, the third announcement message can comprise a Hello message such as that shown in FIG. 5 and described in detail below. In this implementation, the Hello message comprises, among other information, a flag that which indicates that the desired service is no longer available to the client nodes 111, 112 and that the leader node 119 is about to transition from being the Enhanced Client (EC) node to being the leader node 119. The client nodes 111 and 112 may decide to remain a part of the structured network 110 instead of roaming back to the structured network 120 lead by leader node 128 (e.g., the client nodes 111 and 112 can decide to stay with leader node 119).

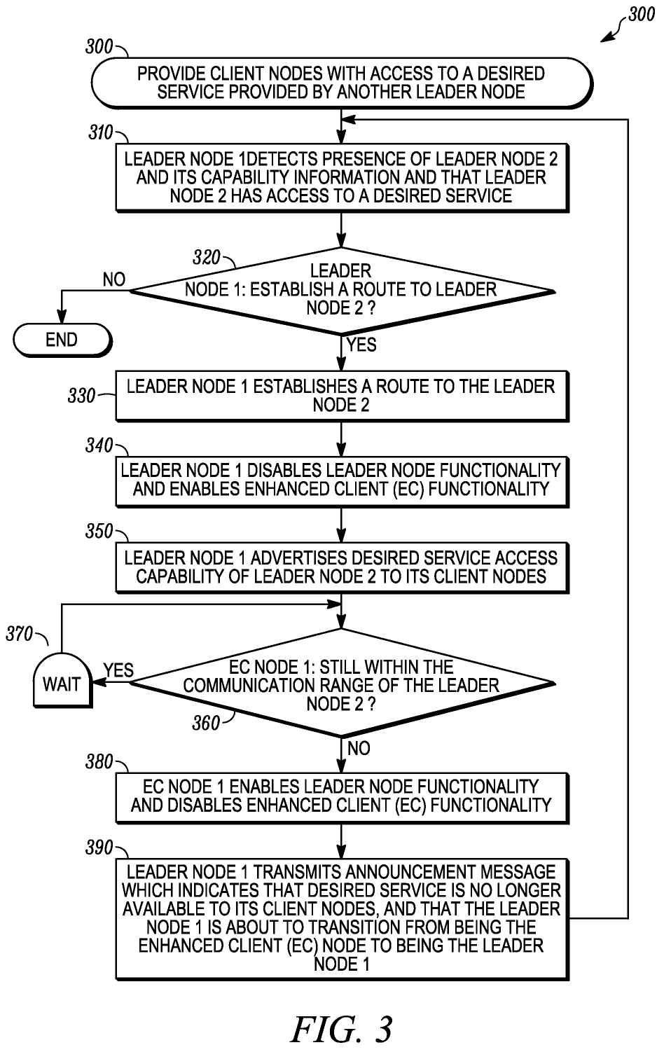

A data structure 400 of an announcement or “Hello” message will now be described with reference to FIG. 4. The data structure 400 can be modified so that the announcement or “Hello” message of FIG. 5 can be used in conjunction with one exemplary implementation of the invention.

FIG. 4 is a data structure 400 showing an exemplary implementation of a Hello message used in accordance with some embodiments of the invention. The Hello message can be used, for example, in conjunction with an ad hoc Mesh Scalable Routing (MSR) protocol such as that reference above.

The Hello message includes a version number field 410 which specifies a version number of the bridging protocol, a type field 420 which specifies the message type, a hops-to-leader node field 430 which specifies the number of hops to the leader node, a next hop-to-leader node address field 440 which specifies a MAC address of the next hop neighbor for a route to the leader node, a routing metrics field 450 which specifies routing metrics associated with the route to the leader node, a flag(s) field 460 which is reserved for future use, an I field 470 which when asserted means that the route reply (RREP) is from the leader node, a T field 480 which indicates the type of bridge leader node, and a leader node MAC address field 490 which specifies the MAC address of the leader node. The routing metrics field 450 is updated at each hop (e.g., each hop adds to the routing metrics) along the route. The routing metric is calculated as a function of number of hops, success rate along a path, current signal strength etc. In one implementation, the flag field 460 can be used to advertise services that are available from a particular node. For example, services that are available from a particular node can be advertised in a mask in field 460 of the announcement message. This way, a node can check the mask of each announcement message against its own mask. When the node determines that the mask is different than its own mask, the node can take appropriate action.

FIG. 5 is a data structure 500 showing an exemplary implementation of a Hello message used in accordance with some exemplary embodiments of the invention. The modified Hello message includes some of the same fields as the Hello message of FIG. 4, and for sake of simplicity, these fields will not be described again. The modified Hello message also includes an N flag 582 in the flags field 560 and a new leader node MAC address 595. When the state of the N flag 582 is in a first state, the N flag 582 can be used to indicate that a new leader node is available, that the current leader node is about to transition to an Enhanced Client, and that the client nodes to update their routing tables with the MAC address of the new leader node and also to use the old leader node as the next hop to the new leader node. When the state of the N flag 582 is in a second state, the N flag 582 can be used to indicate that a desired service is no longer available to the client nodes of a new leader node and that an Enhanced Client (EC) node is about to resume being a leader node for the client nodes (or transition from being the Enhanced Client (EC) node to being a new leader node).

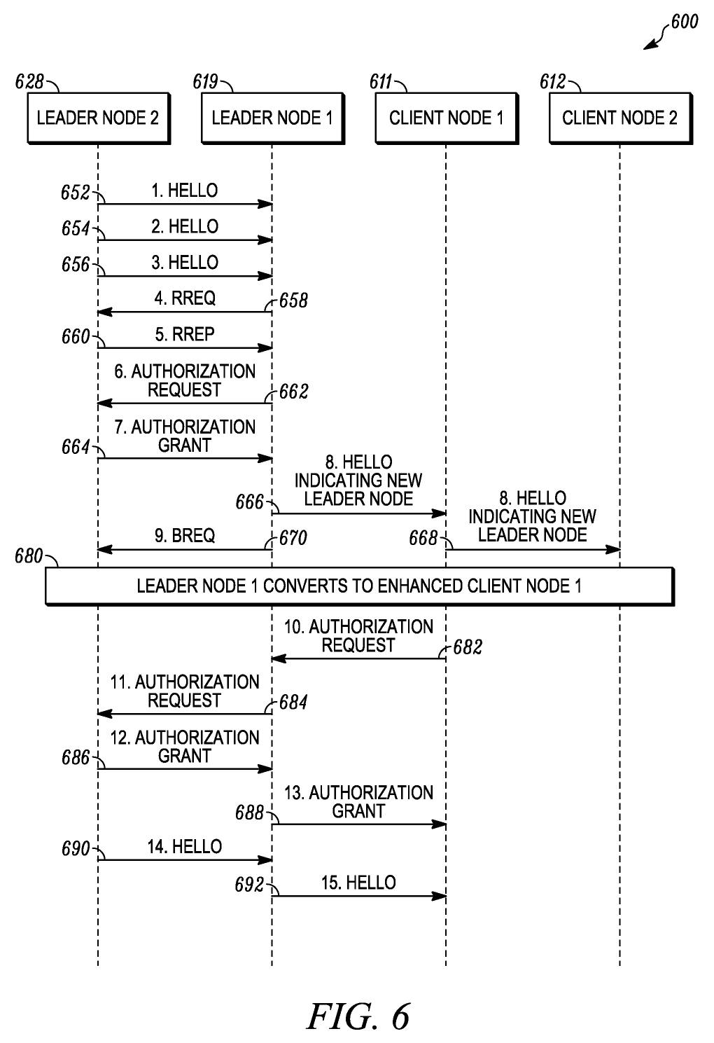

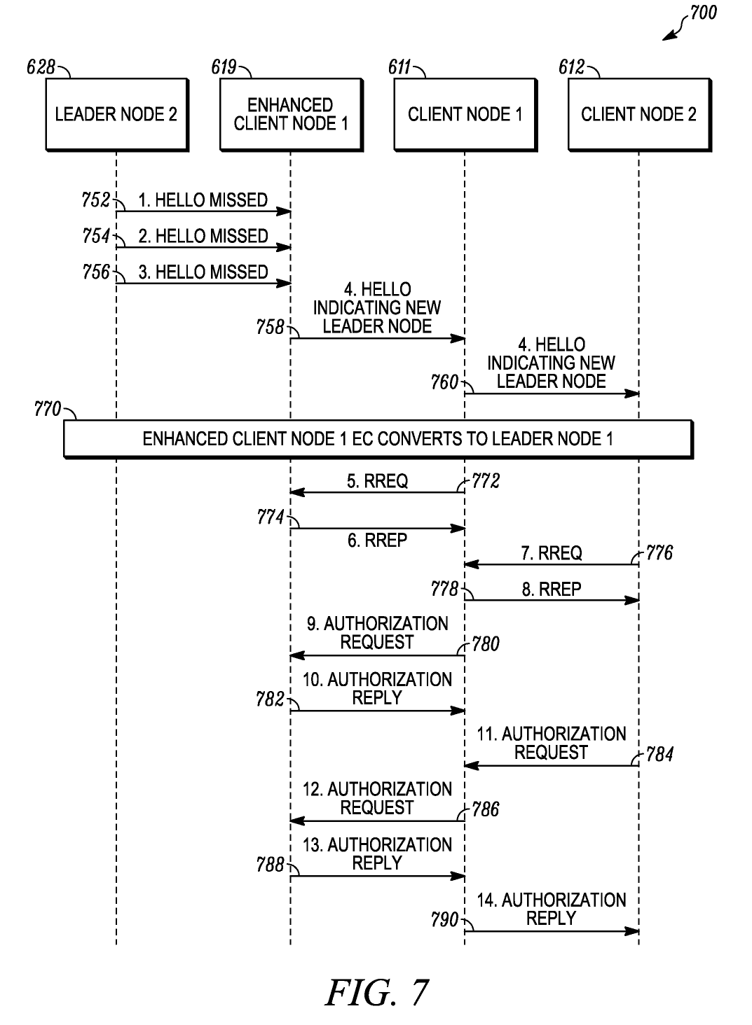

FIGS. 6 and 7 illustrate exemplary scenarios when a leader node 619 without access to a desired service encounters a new leader node 628 with access to the desired service. As will be described below with reference to FIG. 6, the leader node 619 converts from being a leader node to being an Enhanced Client (EC) node, and client nodes 611, 612 associated with leader node 619 will eventually have access to the desired service via leader node 628. As will be described below with reference to FIG. 7, when the node 619 leaves the communication range of leader node 628, the node 619 converts from being an Enhanced Client (EC) node back to being a leader node 619. At this point the client nodes 611, 612 will no longer have access to the desired service via leader node 628.

FIG. 6 is a message flow diagram showing messages exchanged when a leader node 619 converts from being a leader node to being an Enhanced Client (EC), and client nodes 611, 612 associated with that leader node 619 gain access to a desired service provided by another leader node 628 according to one exemplary implementation. In the exemplary implementation shown in FIG. 6, an AODV-like on-demand protocols (e.g., ad-hoc on demand distance vector (AODV), (RFC 3561), dynamic source routing (DSR) (Internet Draft), and so forth) is used as the ad hoc routing protocol to establish a route between nodes 619, 628 upon detecting the leader node 628 that offers access to a desired service (e.g., a backhaul service).

In this example, the leader node 619 can be a node that provides local coverage around a command van (e.g., it has a wireless network in vehicle used as a mobile base of operation). In this example, the leader node 628 has access to a desired service and indicates so in its announcement message (e.g., Hello message).

The leader node 628 regularly transmits a Hello message that can be received by other leader nodes that are within (or that eventually come within) its communication range. This is shown at steps 652-656. When the leader node 619 comes into range of leader node 628 and receives a fixed multiple of Hello messages from the leader node 619, it starts the process of transitioning to an Enhanced Client (EC) node. An EC node has a local area network and is a client but does not perform the functions of a leader node.

As step 656, the leader node 619 eventually receives one of these Hello messages, and uses it to detect the presence of leader node 628. The Hello messages include, among other information, information regarding the capabilities of the leader node 628 including information about services the leader node 628 can offer or provide to other nodes.

At step 658, the leader node 619 transmits a Route Request (RREQ) packet to leader node 628 to establish a route to the leader node 628. At step 660, upon receiving the Route Request (RREQ) packet, the leader node 628 can transmit a Route Reply (RREP) packet to leader node 619 to establish a route to the leader node 628.

Once the route is established between the leader node 619 and the leader node 628, at step 662, the leader node 619 transmits an authorization request message to leader node 628, and at step 664, the leader node 628 can transmit an authorization grant message to the leader node 619 if the leader node 628 decides to grant access to the desired service to the leader node 619 and its client nodes 611, 612. The leader node 628 can also authenticate leader node 619 prior to granting access to any services offered or provided by the leader node 628.

At step 666, the node 619 transmits a Hello message to client node 611 indicating a MAC address of the leader node 628, that leader node 628 is the new leader node is available, and that node 619 has converted to EC node 619. At step 668, client node 611 forwards this Hello message to client node 612. The client nodes 611, 612 receiving this Hello message update the route to the new leader node 628 with node 619 as the next hop toward leader node 628. After receiving this Hello message, the client nodes assume that the node 619 is an Enhanced Client (EC) node and that their leader is now leader node 628. The EC node 619 stops sending out its own announcement messages, and forwards the announcement (Hello) messages sent out by leader node 628 to client nodes 611, 612. The client nodes 611, 612 do not send route discovery messages to leader node 628.

At step 670, node 619 sends a bind request message to 628 to leader node 628. The bind request message includes all the MAC addresses that were in a bind table of node 619. Thus the new leader node 628 learns all of the client nodes 611, 612 in the network. At step 680, node 619 disables its “leader” node functionality, enables enhanced client functionality, transmits appropriate messages to leader node 628 and client nodes 611, 612, and converts from a “leader” node to an enhanced client node 619 that continues to provide some service(s) to client nodes 611, 612.

At step 682, the client node 611 transmits an authorization request message to EC node 619, and at step 684, the EC node 619 can forward or relay the authorization request message to leader node 628. At step 686, the leader node 628 can transmit an authorization grant message to the EC node 619 if the leader node 628 decides to grant access to the desired service to the EC node 619 and its client nodes 611, 612. At step 688, the EC node 619 can then forward or relay the authorization grant message to client node 611. Although not shown in FIG. 6, a similar process can take place for client node 612 so that client node 612 can be granted access. In one implementation, the leader node 628 can also authenticate client nodes 611, 612 prior to granting access to any services offered or provided by the leader node 628.

At step 690, leader node 628 transmits a Hello message that EC node 619 receives and forwards or relays to client node 611 and, although not shown, to client node 612.

FIG. 7 is a message flow diagram 700 showing messages exchanged when an Enhanced Client (EC) node detects that it is no longer within the communication range of the leader node and also resumes its role as a leader node according to one exemplary implementation.

As noted above, the leader node 628 regularly transmits a Hello message to other leader nodes that are within (or that eventually come within) its communication range. When the EC node 619 determines that it has left the communication range of the leader node 628 (e.g., stops receiving a certain number of announcement messages over a certain time interval as shown at steps 652-656), the EC node 619 transitions back to being a leader node which performs the functions of a leader node. At step 758, the leader node 619 transmits a Hello message to client node 611 to indicate that node 619 is the new leader node 619. The Hello message to client node 611 indicates a MAC address of the leader node 619, that leader node 628 is no longer available, and that node 619 has converted back to a leader node. At step 760, upon receiving the Hello message, client node 611 can forward or relay the Hello message to client node 612. The client nodes 611, 612 receiving this Hello message update the route to the leader node 619 and remove the leader node 628 from the route. After receiving this Hello message, the client nodes assume that their leader is now leader node 619. The leader node 619 starts sending out its own announcement messages to client nodes 611, 612.

At step 770, node 619 enables its leader node functionality, disables EC functionality, and converts back to a leader node for clients 611, 612 and starts to provide service(s) to client nodes 611, 612 again.

At step 772, the client node 611 transmits a route request message (RREQ) message to the leader node 619. At step 774, the leader node 619 transmits route reply message (RREP) to the client node 611. At step 776, the client node 612 transmits a route request message (RREQ) message to the client node 612. At step 778, the client node 611 transmits route reply message (RREP) to the client node 612.

At step 780, the client node 611 transmits an authorization request message to the leader node 619. At step 782, the leader node 619 transmits authorization reply message to the client node 611.

At step 784, the client node 612 transmits an authorization request message to the client node 611, and at step 786 the client node 611 forwards the authorization request message to the leader node 619. At step 788, the leader node 619 transmits authorization reply message to the client node 611, and at step 790 the client node 611 forwards the authorization reply message to the client node 612.

### Exemplary Application

In one exemplary application, the techniques described herein can be applied in the context of an Incident Scene (IS) where a command van has a first leader node that provides coverage to client nodes around the command van.

In this scenario, the first leader node provides more structure to client nodes of the ad hoc network. The first leader node can help to reduce and/or minimize route discovery overhead, enable easy management of the ad hoc network by providing a central location for association information, and can make authentication of nodes simpler as opposed to having to do client-client authentication in the ad hoc network. The first leader node can scan for announcement messages from other leader nodes.

When the command van comes into range of another “new” leader node that has access to a desired service (e.g., backhaul or infrastructure), the first leader node wirelessly detects the presence of the new leader node by receiving, over a wireless channel, an announcement message with the new leader node's capability information, and can decide to provide access to the desired service to its client nodes. The first leader node can establish a route to the new leader node, authenticate, and sending all its client information to the new leader node.

The first leader node can send an announcement message indicating that it is about to transition to being an Enhanced Client (EC) node and a new leader node is available. The MAC address of the new leader node can be included in the announcement message along with an indication that the new leader node is available and the first leader node is about to transition to being an Enhanced Client (EC) node.

In this case, the first leader node can dynamically switch its functionality to an Enhanced Client (EC) and stop functioning as the leader node to its client nodes around it when it comes into coverage of the new leader node which has access to the desired service. The first leader node can send an announcement message to its client nodes indicating that a new leader node is available; the client nodes can subsequently update their routing tables with an address of the new leader node and also use the EC as the next hop to the new leader node.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method, comprising:
detecting, at a first leader node which provides at least one service to client nodes and does not have access to a desired service, a second leader node which has access to at least one desired service when the first leader node enters a communication range of the second leader node; and
advertising, at the first leader node, desired service access capability of the second leader node to the client nodes of the first leader node to offer desired service access to the client nodes.

2. A method according to claim 1, further comprising:
disabling leader node functionality offered by the first leader node to client nodes of the first leader node when the first leader node detects the presence of the second leader node; and
enabling Enhanced Client (EC) functionality at the first leader node when the first leader node detects the presence of the second leader node such that the first leader node becomes an EC node which continues to provide the service to the client nodes.

3. A method according to claim 1, wherein detecting, at a first leader node which does not have access to a desired service, a second leader node which has access to a desired service when the first leader node enters the communication range of the second leader node, comprises:
receiving an announcement message over a wireless channel from the second leader node at the first leader node when the first leader node enters the communication range of the second leader node, wherein the announcement message comprises capability information of the second leader node;
analyzing the capability information of the second leader node at the first leader node; and
determining that second leader node has access to the desired service based on the capability information.

4. A method according to claim 3, wherein the announcement message comprises a first announcement message, and wherein advertising, at the first leader node, desired service access capability of the second leader node to the client nodes of the first leader node to offer desired service access to the client nodes, comprises:
transmitting a second announcement message from the first leader node, wherein the second announcement message comprises an indication which indicates that the first leader node is about to transition to being an Enhanced Client (EC) node and that the second leader node is providing the client nodes of the first leader node with access to the desired service.

5. A method according to claim 3, further comprising:
deciding, at the first leader node, to establish a route to the second leader node based on the access to the desired service offered by second leader node;
establishing a route from the first leader node to the second leader node;
transmitting a bind request message from the first leader node to the second leader node, wherein the bind request message associates the first leader node to the second leader node;
authenticating the first leader node at the second leader node; and
transmitting client node information for the client nodes from the first leader node to the second leader node.

6. A method according to claim 4, wherein the second announcement message comprises a Hello message which comprises a MAC address of the second leader node.

7. A method according to claim 6, wherein the Hello message comprises a flag that which indicates that the second leader node is providing the client nodes with access to the desired service and that the first leader node is about to transition to being an Enhanced Client (EC) node.

8. A method according to claim 2, further comprising:
enabling leader node functionality offered by the first leader node to client nodes of the first leader node when the first leader node determines that the second leader node is no longer within the communication range of the first leader node; and
disabling Enhanced Client (EC) functionality at the first leader node when the first leader node determines that the second leader node is no longer within the communication range of the first leader node.

9. A method according to claim 8, further comprising:
transmitting a third announcement message from the first leader node, wherein the third announcement message comprises an indication which indicates that the desired service is no longer available to the client nodes and that the first leader node is about to transition from being the Enhanced Client (EC) node to being the first leader node and that the first leader node is continuing to provide the client nodes of the first leader node with access to the service.

10. A method according to claim 8, wherein the third announcement message further comprises a second Hello message comprising a MAC address of the first leader node, wherein the second Hello message comprises a flag that which indicates that the desired service is no longer available to the client nodes and that the first leader node is about to transition from being the Enhanced Client (EC) node to being the first leader node and that the first leader node is continuing to provide the client nodes with access to the service offered by the first leader node.

11. A method according to claim 1, wherein the second leader node is part of a structured network.

12. A method according to claim 11, wherein the structured network comprises a structured ad hoc network.

13. A method according to claim 11, wherein the second leader node comprises at least one of an access point (AP), a mobile node and a base station.

14. A method according to claim 11, wherein the first leader node is part of an ad hoc network, and provides services to the client nodes in the ad hoc network before entering the communication range of the second leader node.

15. A method according to claim 14, wherein the ad hoc network comprises a structured ad hoc network.

16. A method according to claim 14, wherein the first leader node comprises at least one of an access point (AP), a mobile node and a base station.

17. A method according to claim 1, further comprising:
providing access to the desired service, to the client nodes of the first leader node, at the second leader node.

18. A node which provides at least one service to client nodes and does not have access to a desired service, the node comprising:
a processor configured to detect presence of a second leader node which has access to at least one desired service when the first leader node enters communication range of the second leader node; and
a transmitter configured to transmit an advertisement message to the client nodes of the first leader node, wherein the advertisement message comprises an indication which indicates that the second leader node is offering the client nodes access to the desired service.

19. A node which provides access to a desired service, the node comprising:
a processor configured to detect presence of a leader node when the leader node enters communication range of the node; and
a transmitter configured to transmit an advertisement message to the leader node, wherein the advertisement message comprises an indication which indicates that the node is offering access to the desired service to client nodes of the leader node.
